(19) United States
(12) Patent Application Publication
(10) Pub. No.: US 2020/0236964 A1
(43) Pub. Date: Jul. 30, 2020

(54) METHOD FOR COLLECTING PROTEINS FROM WASHWATER AND/OR WASTEWATER

(71) Applicant: MPF, Inc., Kensington, NH (US)

(72) Inventors: Stanley H. Hultin, Kensington, NH (US); Hordur G. Kristinsson, Kensington, NH (US); Alex Riemann, Kensington, NH (US)

(73) Assignee: MPF, Inc., Kensington, NH (US)

(21) Appl. No.: 16/482,905

(22) PCT Filed: Feb. 1, 2018
(86) PCT No.: PCT/US18/16398

§ 371 Date: Aug. 1, 2019

Related U.S. Application Data
(60) Provisional application No. 62/453,142, filed on Feb. 1, 2017.

(51) Int. Cl. A23J 1/00; A23K 10/26; A23K 20/147; A23J 3/00

(52) U.S. Cl. CPC A23J 1/001; A23J 3/00; A23K 20/147; A23K 10/26

(57) ABSTRACT

A method of collecting proteins from a washwater and/or wastewater stream by means of a pH shift technique, aided with dissolved bubbles of air or gases, in order to substantially reduce the environmental impact of wastewater discharge and improve the value of the recovered protein. The pH shift process can coagulate and recover the protein at low temperatures (−1 to 10 degrees Celsius) making the proteins recovered suitable for human food applications, without heating.

### FIELD

The present disclosure relates generally to methods for collecting protein from a liquid medium, such as washwater and/or wastewater, in the production of human or animal food, as well as in non-food applications.

### BACKGROUND

In the meat and fish processing industries, protein slurries are produced incidentally to the desired process in mechanical filleting, deboning, cutting and skinning of animals where the cutting is aided with a direct water spray in the area where the knife contacts the muscle tissue. The practice of washing muscle tissue is common in many food industries, for example the surimi industry, where substantial volumes of protein rich washwater solutions are generated. In the abovementioned cases, water consumption can be as much as 100 liters per minute or pound of meat processed. Such a volume of liquid can contain 0.2-4% dissolved and suspended protein which has a high biological oxygen demand (BOD) and high chemical oxygen demand (COD) and therefore can be a significant environmental pollutant. Bleeding of animals and gutting also leads to a substantial accumulation of soluble proteins in washwater leaving a plant, whether aided by water sprays or not. Substantial protein losses can also be experienced during processing of agricultural commodities, e.g. soy, legume, corn, wheat, algae and milk.

Current methods only allow for very limited recovery of protein from washwaters (and wastewater) and lead to large economic losses and pollution. Current solutions to effectively remove protein from washwater and wastewater include costly treatment plants, which typically involve use of non-food grade polymer flocculants, and other approaches that add significant costs but capture little or no value and thus lead to waste of valuable food protein. Heat treatment is often required to coagulate and collect proteins from washwater and wastewater, which leads to substantial losses of functionality, thus rendering the protein unsuitable for food applications. Current approaches using dissolved bubbles or microbubbles of air or gases (typically designated as, but not limited to, the dissolved air flotation (DAF) approach) are only marginally effective and collect only non-soluble proteins in a highly inefficient way unless non-food grade polymer flocculants are used, which render the final products inedible even for animal feed.

Presently there is a need to remove these proteins before discharging the water into the environment or sending large quantities of protein laden water to expensive treatment plants. A method to recover food and feed grade functional proteins from wastewater and washwater at low temperatures and without the need of non-food grade flocculants would open up new opportunities for proteins that are now being discarded or used for non-food or feed purposes, creating significantly more value and lessening environmental pressures. To date, most methods for recovering quality protein from washwater or wastewater streams have been too costly or ineffective, requiring commitment to large expensive dedicated facilities for water treatment. The recovered solids from such treatment facilities are also of low or no value.

### BRIEF SUMMARY

The disclosure described herein provides for an improved method of concentrating proteins in a washwater and wastewater stream by means of a pH shift technique, aided with dissolved bubbles of air or gases, in order to substantially reduce the environmental impact of wastewater discharge and improve the value of the recovered protein. The pH shift process can coagulate and recover the protein at low temperatures (−1 to 10 degrees Celsius), thus making the proteins recovered suitable for human food applications, without heating. Advantageously, pH shift can be used to facilitate the coagulation and collection of sarcoplasmic proteins and/or blood proteins and/or suspended myofibrillar proteins and/or other proteins at low or high temperature with low cost, low shear, and high volume unit processes. With this approach, washwater or wastewater released into the environment can be greatly reduced of protein and other water solubles. Lipids and lipid soluble compounds can also be effectively removed.

Further examples of the methods of this disclosure may include one or more of the following, in any suitable combination.

Examples of the method for collecting proteins from washwater and/or wastewater of this disclosure include: 1) initially lowering or raising the pH of a slurry containing coagulated proteins, wherein the proteins are dissolved and/or structurally modified by the initial lowering or raising of the pH; 2) subsequently lowering or raising the pH of the protein-containing slurry at or near an isolelectric point of the proteins, wherein the proteins are re-coagulated by the subsequent lowering or raising of the pH; 3) incorporating bubbles into the protein-containing slurry, wherein incorporating the bubbles into the slurry enhances the re-coagulation of the proteins, forming a protein-rich layer at a surface of the slurry; and 4) collecting the protein-rich layer. In examples, the method further includes concentrating the protein-rich layer with a separation technique which is not a coagulant, such as by screening, ultrasound, electrocoagulation, filtration, centrifugation and skimming.

In further examples, initially lowering the pH of the protein-containing slurry includes initially lowering the pH to 1-5, while initially raising the pH of the protein-containing slurry includes initially raising the pH to 7-14. In examples, the bubbles comprise one or more of air, oxygen, nitrogen, carbon dioxide and carbon monoxide, alone or in combination. In further examples, the method includes dissolving the bubbles in a pre-selected quantity of water under pressure. In examples, subsequently lowering the pH of the protein-containing slurry includes adding to the slurry an acid selected from a group of hydrochloric acid, phosphoric acid, acetic acid and citric acid, while subsequently raising the pH of the protein-containing slurry includes adding to the slurry a base selected from a group of sodium hydroxide, potassium hydroxide and calcium hydroxide. In examples, the method is performed as a batch-type process or a continuous flow process.

In yet further examples, the method includes adding to the protein-containing slurry a salt in an amount of about 0.1% to about 10% of the volume of the slurry. In examples, the method includes, after subsequently lowering or raising the pH of the protein-containing slurry, maintaining the slurry at the subsequent low or high pH for a period of about 1 second to about two hours. In further examples, the method includes, before subsequently lowering or raising the pH of the protein-containing slurry, heating the protein-containing slurry to a temperature greater than 10° C. In examples, subsequently lowering or raising the pH of the protein-containing slurry comprises subsequently lowering or raising the pH of the slurry to about pH 4-7, or to about pH 5.5. In further examples, the method includes adding to the protein-containing slurry a process chemical selected from a group of food grade polymer coagulants, polyphenols, hemoglobin and myoglobin. In examples, collecting the protein-rich layer comprises one of skimming, suctioning, screening or centrifugation. In examples, collecting the protein-rich layer by screening comprises collecting the protein-rich layer with a filtration screen having a pore sizes of about 1 to about 1200 nanometers. In further examples, the method includes processing the protein-rich layer by one or more of hydrolyzing, fractionating, heating, pasteurizing, pressurizing, concentrating or drying. In examples, the bubbles comprise one or more of microbubbles, nanobubbles or micro-nano bubbles. In further examples, subsequently lowering or raising the pH of the protein-containing slurry comprises subsequently lowering or raising the pH at a temperature between about −1° C. and about 10° C. In examples, the bubbles comprise air. In further examples, incorporating the bubbles into the protein-containing slurry is performed substantially at the same time as subsequently lowering or raising the pH of the protein-containing slurry.

These and other features and advantages will be apparent from a reading of the following detailed description. It is to be understood that both the foregoing general description and the following detailed description are explanatory only and are not restrictive of aspects as claimed.

### DETAILED DESCRIPTION

Examples of the method for collecting proteins from wastewater and/or washwater will now be discussed.

As used herein, for the purposes of describing and defining the invention, the terms “about” and “substantially” represent the inherent degree of uncertainty that may be attributed to any quantitative comparison, value, measurement, or other representation. The terms “about” and “substantially” are also used herein to represent the degree by which a quantitative representation may vary from a stated reference without resulting in a change in the basic function of the subject matter at issue. “Comprise,” “include,” and/or plural forms of each are open ended and include the listed parts and can include additional parts that are not listed. “And/or” is open-ended and includes one or more of the listed parts and combinations of the listed parts.

### Definitions

As used herein, the term “batch-type process” refers to process steps of materials undergoing various different treatments and/or reactions that are performed stage by stage over a series of workstations.

As used herein, the term “centrifugation” refers to process of separating lighter parts of a solution, mixture, or suspension from the heavier parts by spinning and centrifugal force.

As used herein, the term “coagulated proteins” refers to proteins that are aggregated or linked together in a group of semi-soft solid like structures.

As used herein, the term “continuous flow process” refers to a process where the materials that are being processed are continuously in motion and undergoing various different treatments and/or reactions.

As used herein, the term “dissolved” refers to a compound that becomes incorporated into a liquid so as to form a solution.

As used herein, the term “electrocoagulation” refers to a process where electrical charge is applied to a solution causing dissolved or suspended matter to coagulate.

As used herein, the term “flocs” refers to a loosely clumped or coagulated mass of fine particles.

As used herein, the term “fractionating” refers to a process where certain parts of a mixture are separated from other parts of the same mixture.

As used herein, the term “hemoglobin” refers to an iron containing protein derived from red blood cells responsible for transporting oxygen.

As used herein, the term “hydrolyzing” refers to a process where a compound (e.g. protein) is broken down into smaller units via a chemical or enzymatic action.

As used herein, the term “isoelectric point” refers to the pH at which a particular molecule carries no net electrical charge.

As used herein, the term “microbubbles” refers to bubbles having a diameter between about one micrometer and about one millimeter.

As used herein, the term “micro-nanobubbles” refers to bubbles having a diameter between about one nanometer and about one micrometer.

As used herein, the term “myoglobin” refers to an iron containing protein found in muscle tissue and is responsible for transporting oxygen.

As used herein, the term “nanobubbles” refers to bubbles having a diameter less than about one nanometer.

As used herein, the term “permeate” refers to liquid that has passed through a filter.

As used herein, the term “polymer coagulants” refers to compounds that have the ability to induce coagulation of other compounds, such as protein and fat molecules.

As used herein, the term “polyphenols” refers to compounds containing more than one phenolic group.

As used herein, the term “pressurizing” refers to a process of producing or maintaining raised pressure (above atmospheric pressure) artificially.

As used herein, the term “protein-rich layer” refers to a part of a mixture which has a concentration of protein that is greater than the concentration of wastewater and/or washwater.

As used herein, the term “retentate” refers to matter which is retained by a filter or a porous membrane.

As used herein, the term “screening” refers to a process of separating out insoluble material from a mixture by passing them through a perforated screen filter.

As used herein, the term “skimming” refers to the process of removing a substance from the surface of a mixture or solution.

As used herein, the term “slurry” refers to a suspension of solid particles in a liquid.

As used herein, the term “structurally modified” refers to a process of changing the molecular structure/conformation of a molecule, for example a protein molecule.

As used herein, the term “suctioning” refers to a process of removing a part of a mixture or solution using suction.

As used herein, the term “supernatant” refers to a liquid overlying material that has been deposited/sedimented by settling, precipitation or centrifugation.

As used herein, the term “ultrasound” refers to sound or other vibrations having a frequency greater than 20000 Hertz.

The method described herein provides for any proteins not already water soluble being dissolved or otherwise structurally modified at either low pH (between 1-5) or high pH (between 7-14), and then, along with other soluble proteins, being coagulated by adjusting the pH to at or within range of the known isoelectric point of the proteins where the solubility of the majority of the proteins is at minimum. This results in particles of coagulated protein flocs that are much larger and denser, and which represent a greater percentage of the total dispersed protein, than were in a non-soluble form in the original slurry. The slurry which has been coagulated by the pH shift process also includes some content of proteins still in the soluble state, which would not aggregate under these conditions, but at much reduced concentration relative to the starting slurry prior to the pH shift process. The increase in size and density of the proteins flocs along with the reduced content of remaining soluble proteins allows for much easier dewatering (protein recovery) when this slurry is subjected to common dewatering techniques which involve either gravitational/centrifugal forces and/or screen collection methods. These methods can however be made even more efficient by subjecting the pH shift-induced, coagulated slurry to a chamber wherein dissolved bubbles (which may include microbubbles, nanobubbles or micro-nano bubbles) of air or other gases result in modification of the surface active properties of the protein flocs, as well as their buoyancy due to bubble attachment, so that the protein flocs form even larger floc sizes and their buoyancy is increased (density decreased). This leads to rapid flotation of such flocs to the air-water interface of the chamber and results in formation of a dense protein-rich layer which can be more easily recovered by skimming and subsequent screening and/or centrifugation (bubbles are easily released in this operation such that the floc density is increased). The bubbles are either made with air or with various other gases, including but not limited to: oxygen, nitrogen, carbon dioxide, carbon monoxide, alone or in various combinations with other gases or air. The bubbles can first be dissolved in a specified volume of water, wastewater and washwater under pressure and then a volume of this water released into a tank or tubular system containing the wastewater and/or washwater. The bubbles can also be released directly into a tank or tubular system containing the wastewater and/or washwater. The term bubbles of air and/or other gases refers to both above examples.

While it is known that incorporation of air or other gases into protein solutions has the ability to create foams, the foams of proteins in washwater and wastewater are inherently unstable and voluminous and not practical with respect to protein recovery. Surprisingly, and not known until now, incorporation of bubbles of air or other gases at or after the protein coagulation pH step, result in formation of highly stable, larger protein flocs which can be more easily recovered and (if needed) dewatered, resulting in useful food- and feed-grade products. Without intending to be bound by theory, the addition of the air bubbles results in stronger bonding between protein particles as they apparently induce increased protein surface hydrophobicity and thus protein-protein hydrophobic bonding. Once the proteins are unfolded (partially or fully) at the low or high pH, both the myofibrillar and sarcoplasmic (including blood) proteins of animal muscle origin will coagulate together at the precipitation pH (‘isoelectric point’) of the myofibrillar proteins, or at pH values close to the isoelectric point, increasing their size and density of the flocs. Proteins of plant, algae or microbial origin and proteins derived from milk will demonstrate the same behavior as they are unfolded (partially or fully) at low or high pH, forming coagulates once adjusted to their precipitation pH (isoelectric point(s)) or pH values close to the isoelectric point.

Washwater or wastewater from processing operations typically come in significant volumes. The protein containing wastewater can be collected in stainless steel batch type tanks, or can be processed in a continuous flow. The pH of the wastewater/washwater is monitored by in-line pH probes, and is adjusted either to a low pH (1-5) or high pH (7-14) by dosing into the wastewater/washwater HCl or NaOH, respectively. Different concentrations of acid and base can be used, depending on the nature of the protein slurry. If the process is continuous flow (e.g. in pipes) the acid or base is dosed directly into the wastewater/washwater with or without agitation. If the process is batch type, then the acid and base is dosed into the wastewater/washwater under gentle agitation to allow it to disperse well into the wastewater/washwater. Alternative weak and strong acids and bases other than HCl and NaOH can be used to adjust pH, for example phosphoric acid, acetic acid, citric acid, potassium hydroxide, calcium hydroxide etc. Increasing the ionic strength at both low and high pH via addition of salts, including but not limited to NaCl, KCl, in the range of 0.1-10% of the volume of the slurry can be an additional step aiding in the recovery of the proteins in the wastewater/washwater. Higher ionic strength may allow for milder acid or alkaline pH values than solutions with lower ionic strength, which may significantly reduce acid/base costs and volume requirements, and increase the practicality of using this process commercially at high volumes. Without intending to be bound by theory, the low and high pH increases the charge of the proteins causing them to unfold either partially or fully, depending on the pH, duration of time at the pH and other solvent conditions. This charge induced unfolding solubilizes the proteins due to electrostatic repulsion between them. The wastewater/washwater is held at the low or high pH for a period of 1 second to 2 hours. In some applications it may be more effective recovering the protein by holding the wastewater/washwater at low or high pH longer than 2 hours. In some applications it may be preferable to heat-treat the proteins (>10° C.) for a certain period of time at low or high pH prior to pH re-adjustment from low or high pH to improve the recovery of the proteins. In applications where the primary goal is the minimization of all proteins in the permeate, such as in applications where biochemical oxygen demand (BOD) must be minimized, it may be more effective to utilize the acidic dissolution process as described above.

After holding at low or high pH, the wastewater and/or washwater is then adjusted to a pH range where protein solubility is at minimum or is low, or about pH 4-7, preferably close to pH 5.5 (in case of animal based protein). The protein(s) do not have to be at their exact isoelectric point to recover them with the aid of the bubbles. It may be preferable in certain cases to adjust the pH of the wastewater or washwater to a pH value slightly away from the isoelectric point to obtain a protein of different functionality or quality while still achieving highly effective coagulation and recovery of proteins. The high pH slurry is adjusted down in pH with acid, for example but not limited to HCl. The low pH slurry is adjusted up in pH with alkali, for example but not limited to NaOH. This results in the partial refolding of the unfolded proteins, leaving exposed hydrophobic areas, which causes them to coagulate since protein/protein interactions become stronger than protein/water interactions. The coagulated proteins form protein flocs, which are significantly larger in size and have more density and lower solubility than proteins or protein flocs that may form in the original wastewater/washwater prior to pH shifting. In the case of animal based proteins, the presence of myofibrillar proteins in the wastewater/washwater may aid in the coagulation and recovery of the sarcoplasmic or blood proteins in the wastewater/washwater.

Incorporation of bubbles or of air or other gases causes a further strengthening of the protein-protein interactions of the flocs by increasing hydrophobic bonding between flocs such that they coagulate into much larger protein flocs which consist primarily of protein, or bubbles of air and/or gas and water. The combination of partially unfolding the protein at low or high pH, followed by partially refolding them by readjusting pH to a pH value at or slightly away from the protein(s) isoelectric point, followed by introduction of bubbles of air and/or other gases, synergistically works to create exceptionally strong protein-protein interactions, driven by strong hydrophobic forces that overcome any repulsive electrostatic forces. Furthermore, the incorporation of bubbles causes changes in the buoyancy of the protein flocs such that they very rapidly migrate to the air/water interface where a thick protein rich layer (foam) is produced. Without the incorporation of bubbles of air and/or other gases, recovery (precipitation or flotation) of proteins is substantially slower, up to 24 hours, while it can be achieved in seconds with the combination of pH shift and incorporation of bubbles of air and/or other gases.

The pH adjustment can take place during gentle agitation/flow or during rapid agitation/flow to ensure the formation of appropriate coagulated flocs of proteins. The microbubble or bubble air and/or gas incorporation can take place during gentle agitation/flow or during rapid agitation/flow to ensure the formation of larger protein flocs, which rapidly migrate upward in the water milieu to form a thick, protein rich layer (foam) at the surface. The incorporation of bubbles of air and/or gas can take place in a tank, pre-chamber or can take place in a tubular system before the protein slurry enters a tank. In some applications it may be effective to include process chemicals which aid in the protein/protein interactions to more effectively recover the protein, including, but not limited to, food-grade polymer coagulants and other food grade compounds with protein aggregation properties, for example polyphenols, hemoglobin, myoglobin etc. In some applications, dosing of acid or base may be done instantaneously while in other applications it can be done over a certain time period to allow for a more controlled floc formation. In some applications, it may be preferable to maintain the pH of the protein after pH adjustment for a period of time (for example, between one second and two hours) to allow for stronger protein-protein interactions before bubbles of air or gases are introduced. Afterwards, it may be preferred to decant the supernatant before introducing bubbles of air or gases. In some applications, such as animal protein slurry, it may be useful to adjust the slurry from low (or high) pH to the isoelectric pH of the sarcoplasmic proteins before readjusting to the precipitation pH of the myofibrillar proteins for that species.

The aerated coagulated protein layer (foam) can be collected with skimming or suction, and concentrated and recovered using a variety of process methods. In some applications, skimming or sucking off the aerated coagulated protein layer (foam) is sufficient. In some applications the aerated coagulated protein layer (foam) may be further concentrated with various process separation methods, for example with centrifuges, where the protein is further separated from the water fraction and concentrated, as the bubbles easily separate to render the flocs more dense and less buoyant in water. In some applications filtration screens with pore sizes of about 1 to about 1200 nanometers may be used to collect the pH shift coagulated protein. The filtration can be aided by applied controlled pressure. The filtration screen can be made of different materials, including ceramic, polymeric, steel or stainless steel. The retentate which contains the concentrated protein is then collected, and the permeate containing mostly water, can be reused and/or discarded. In some applications it may be preferable to heat-coagulate the protein in the retentate prior to subsequent processing by raising the temperature of the retentate to a temperature above 10° C. This may be useful to further collect proteins already coagulated by pH shift and concentrated. In some applications it may be preferred to use other separation methods such as centrifugal separation methods, using either low or high gravity forces.

In some applications, the recovered protein can be used in human food applications. In some applications, the recovered protein may be useful for fishmeal or animal food applications. In some applications the recovered protein can be further processed, for example hydrolyzed, and used as fertilizer, food or feed. In some applications, the protein-rich layer can be further processed by hydrolyzing, fractionating, heating, pasteurizing, pressurizing, concentrating or drying. In some applications, a fat-rich layer can also be separated from the protein-containing slurry for yielding fat and oil products.

While the methods described herein have been particularly shown and described with references to examples thereof, it will be understood by those skilled in the art that various changes in form and details may be made therein without departing from the scope of the disclosure encompassed by the appended claims.

What is claimed is:

1. A method for collecting proteins from washwater and/or wastewater comprising the steps of:
initially lowering or raising the pH of a slurry containing coagulated proteins, wherein the proteins are dissolved and/or structurally modified by the initial lowering or raising of the pH;
subsequently lowering or raising the pH of the protein-containing slurry at or near an isoelectric point of the proteins, wherein the proteins are re-coagulated by the subsequent lowering or raising of the pH;
incorporating bubbles into the protein-containing slurry, wherein incorporating the bubbles into the slurry enhances the re-coagulation of the proteins, forming a protein-rich layer at a surface of the slurry; and
collecting the protein-rich layer.

2. The method of claim 1, further comprising concentrating the protein-rich layer with a separation technique which is not a coagulant.

3. The method of claim 2, wherein the separation technique is one of screening, ultrasound, electrocoagulation, filtration, centrifugation and skimming.

4. The method of claim 1, wherein the step of initially lowering the pH of the protein-containing slurry comprises initially lowering the pH to 1-5.

5. The method of claim 1, wherein the step of initially raising the pH of the protein-containing slurry comprises initially raising the pH to 7-14.

6. The method of claim 1, wherein the bubbles comprise one or more of air, oxygen, nitrogen, carbon dioxide and carbon monoxide, alone or in combination.

7. The method of claim 1, further comprising dissolving the bubbles in a pre-selected quantity of water under pressure.

8. The method of claim 1, wherein the step of subsequently lowering the pH of the protein-containing slurry comprises adding to the slurry an acid selected from a group of hydrochloric acid, phosphoric acid, acetic acid and citric acid.

9. The method of claim 1, wherein the step of subsequently raising the pH of the protein-containing slurry comprises adding to the slurry a base selected from a group of sodium hydroxide, potassium hydroxide and calcium hydroxide.

10. The method of claim 1, wherein the method is performed as a batch-type process or a continuous flow process.

11. The method of claim 1, further comprising adding to the protein-containing slurry a salt in an amount of about 0.1% to about 10% of the volume of the slurry.

12. The method of claim 1, further comprising, after the step of subsequently lowering or raising the pH of the protein-containing slurry, maintaining the slurry at the subsequent low or high pH for a period of about 1 second to about two hours.

13. The method of claim 12, further comprising, before the step of subsequently lowering or raising the pH of the protein-containing slurry, heating the protein-containing slurry to a temperature greater than 10° C.

14. The method of claim 1, wherein the step of subsequently lowering or raising the pH of the protein-containing slurry comprises subsequently lowering or raising the pH of the slurry to about pH 4-7.

15. The method of claim 1, wherein the step of subsequently lowering or raising the pH of the protein-containing slurry comprises subsequently lowering or raising the pH of the slurry to about pH 5.5.

16. The method of claim 1, further comprising adding to the protein-containing slurry a process chemical selected from a group of food grade polymer coagulants, polyphenols, hemoglobin and myoglobin.

17. The method of claim 1, wherein the step of collecting the protein-rich layer comprises one of skimming, suctioning, screening or centrifugation.

18. The method of claim 17, wherein the step of collecting the protein-rich layer by screening comprises collecting the protein-rich layer with a filtration screen having a pore sizes of about 1 to about 1200 nanometers.

19. The method of claim 1, further comprising processing the protein-rich layer by one or more of hydrolyzing, fractionating, heating, pasteurizing, pressurizing, concentrating or drying.

20. The method of claim 1, wherein the bubbles comprise one or more of microbubbles, nanobubbles or micro-nano bubbles.

21. The method of claim 1, wherein the step of subsequently lowering or raising the pH of the protein-containing slurry comprises subsequently lowering or raising the pH at a temperature between about −1° C. and about 10° C.

22. The method of claim 1, wherein the bubbles comprise air.

23. The method of claim 1, wherein the step of incorporating the bubbles into the protein-containing slurry is performed substantially at the same time as the step of subsequently lowering or raising the pH of the protein-containing slurry.
